(19) United States
(12) Patent Application Publication
(10) Pub. No.: US 2021/0270474 A1
(43) Pub. Date: Sep. 2, 2021

(54) ASSEMBLY FOR PURIFYING AND FOR AIR POLLUTION CONTROL AND METHOD FOR CONTROLLING SUCH AN ASSEMBLY

(71) Applicant: AIR-FISCIENCE, La Ciotat (FR)

(72) Inventors: Paolo BRUNO, Clichy-la-Garenne (FR); Philippe LLORET, Saint-Avertin (FR)

(73) Assignee: AIR-FISCIENCE, La Ciotat (FR)

(21) Appl. No.: 17/262,907

(22) PCT Filed: Aug. 1, 2019
(86) PCT No.: PCT/EP2019/070764

§ 371 Date: Jan. 25, 2021

(30) Foreign Application Priority Data
Aug. 3, 2018 (FR) 18/57306

(51) Int. Cl. F24F 3/16; F24F 11/72; F24F 8/167; B01D 53/86; B01D 53/88; B01D 46/44; B01D 53/72

(52) U.S. Cl. CPC F24F 3/16; F24F 11/72; F24F 8/167; B01D 53/8696; B01D 53/885; B01D 2257/90; B01D 53/72; B01D 2255/50; B01D 2255/802; B01D 2257/70; B01D 46/442

(57) ABSTRACT

An air purification assembly including: a chamber including an air intake for the passage of polluted air, an air outlet for the passage of purified air and a base provided with a means for creating a circulation of forced air in the chamber, a plurality of detachable cartridges housed in the chamber, the cartridges being adapted to be simultaneously traversed by the polluted air circulating in the chamber in order to purify the air, each of the cartridges being provided, at its intake, with an opening and closing mechanism for respectively allowing air to circulate or for blocking the circulation of air through the associated cartridge, the opening and closing mechanisms being controlled by control means configured to open or close the cartridges separately or in combination so as to adapt the air flow as a function of predetermined parameters of the quality of the air to be purified.

The present invention concerns the gaseous fluid treatment assemblies, and more particularly the air purification and pollution control assemblies.

It finds application in all sectors in which there is a need to monitor the quality of the ambient air of a confined space and particularly applies to the purification of the indoor air in all private or collective living spaces, such as the residential buildings, supermarkets, airports, offices, medico-social establishments, nurseries, hospitals, shops, individual houses, transport, gyms.

To combat indoor pollution of a confined space, it is essential to distribute air as pure as possible, that is to say free of impurities such as biocontaminants such as microorganisms (viruses and bacteria), allergens and fine particles, or even toxic gases (VOC volatile organic compounds—Formaldehyde, toluene, benzene, etc.) and odors.

Thus, fixed or transportable air purification assemblies are known for filtering the ambient air of a place, which are based on an air suction system associated to one or more filter(s) in combination and in particular means for treating polluted air by photocatalysis.

However, it often happens that these filtration assemblies have a quick pressure drop and, consequently, a short service life.

In order to increase the service life of such an assembly, the exchange surfaces between the polluted air and the particulate filters can be limited, to the detriment of the efficiency of the purification of the polluted air.

Moreover, the efficiency of the purification of the polluted air is also affected by the maintenance that is made for the air purification assembly.

An air purification assembly, to maintain its maximum efficiency, needs a regular maintenance of the different inner portions thereof, which is often not possible given the complexity of air purification assemblies.

This lack of maintenance also limits their service life.

Moreover, in order to improve the efficiency of an air purification assembly, one can also multiply the filters and increase the exchange surfaces between the polluted air and the filters.

This type of air purification assembly therefore have a significant space requirement.

A compromise between purification efficiency on various classes of pollutants, ease of maintenance, space saving is always difficult with the known air purification assemblies.

The object of the present invention is to propose a solution which corresponds to an evolution of the known air purification assemblies allowing solving all or part of the aforementioned issues and in particular to allow a complete air decontamination ensuring a minimum of pressure drop by being adapted to the level of air pollution in the room.

To this end, the invention concerns an air purification assembly comprising:
a chamber comprising an air inlet for the passage of a polluted air, an air outlet for the passage of a purified air and a base provided with means for carrying out a forced air circulation,
a plurality of removable cartridges housed in said chamber, said cartridges being adapted to be traversed in parallel by the polluted air circulating in the chamber in order to purify it,

each of the cartridges being provided, at the inlet thereof, with an opening and closing mechanism configurable between an open configuration and a closed configuration for respectively allowing air to circulate or for blocking the circulation of air through the associated cartridge,

said air purification assembly further comprising:
a measurement system for measuring parameters representative of the quality of the air to be purified;
control means connected to the measurement system and to the opening and closing mechanism of each of the cartridges, said control means being configured to control the opening and closing mechanisms in order to open and close individually, for example distinctly or in combination, the cartridges so as to adapt the air flow rate depending on parameters representative of the quality of the air to be purified

Thanks to these features, the air purification assembly is versatile and the purification performance can be adapted depending on the air of the places where it is placed and the specific needs depending on the peculiarities thereof, with such removable cartridges which are air purification and decontamination cartridges.

Advantageously, the cartridges are disposed alone on an intermediate air flow section in the chamber, such that the polluted air entering the chamber passes through said intermediate section by circulating only through the cartridge(s) whose opening and closing mechanism is in the open configuration.

Thus, the cartridges are not bypassed or short-circuited, to form obligatory passages to the flow of the air to be purified, which offers an optimized flow in terms of flow rate and without pressure drop in a bypass channel.

Advantageously, the cartridges are placed parallel to each other in respective directions parallel to a main axis of circulation of the air to be purified, and the cartridges are symmetrically distributed around this main axis.

Thus, the cartridges are evenly distributed around this main axis, offering a balancing of the air flow rates circulating in the cartridges and therefore a better management of the purification implemented by these cartridges. Incidentally, this balancing allows better monitoring the wear of the cartridges and thus better monitoring the time when said cartridges need to be replaced.

According to a particular embodiment, the main axis is concentric relative to the air inlet and air outlet of the chamber, thus providing an optimized flow without pressure drop.

According to an advantageous technical configuration, each of the cartridges comprises at least one consumable photocatalytic cell having a photocatalytic filter and a light source intended to irradiate said photocatalytic filter.

Such an assembly is also easy to maintain while offering an improved efficiency of photocatalysis treatment of polluted air.

Advantageously, the air purification assembly comprises at least one downstream filtration module disposed downstream of the cartridges, in the front of the air circulation inside the assembly.

The downstream filtration module(s) will thus allow improving the filtration and therefore the air purification and decontamination assembly, all in a compact and efficient assembly.

According to one feature, the downstream filtration module is removable between an active position where it is disposed on the path of the air circulating inside the purification assembly so as to be traversed by this air and an inactive position where it does not ensure the filtration of the air, these active and inactive positions being controlled by the control means depending on at least one parameter representative of the quality of the air to be purified.

Such a feature is particularly advantageous given that it is possible to adapt the use of the (or each) downstream filtration module depending on the specific needs of the room inside which the air is purified, thus allowing reducing the pressure drops which would be caused by the presence of the (or each) downstream filtration module in the case where this downstream filtration module was not useful.

Preferably, all downstream filtration modules are removable between the active position and the inactive position.

In a particular embodiment, at least one downstream filtration module is a chemical filtration module downstream of the cartridges, in the front of the air circulation inside the assembly.

According to one possibility, the measurement system comprises means for measuring a chemical pollution rate, and the chemical filtration module is removable between an active position and an inactive position (as described above), these active and inactive positions being controlled by the control means depending on this chemical pollution rate.

According to another possibility, the means for measuring a chemical pollution rate is designed to measure a presence of at least one pollutant selected from the volatile organic compounds, the volatile halogenated organic compounds, aldehydes, ammonia, hydrogen sulfide, mercaptans, monoxides and carbon dioxide.

In another particular embodiment, at least one downstream filtration module is a particulate post filtration module downstream of the cartridges, in the front of the air circulation inside the assembly.

According to one possibility, the measurement system comprises means for measuring a fine particle pollution rate, and the particulate post filtration module is removable between an active position and an inactive position (as described above), these active and inactive positions being controlled by the control means depending on this fine particle pollution rate.

Further advantageously, the air purification assembly comprises a particulate pre-filtration module which is upstream of the cartridges, in the front of the air circulation inside the assembly.

In a variant, the particulate pre-filtration module upstream of the cartridges can also be removable between an active position where it is disposed on the path of the air circulating in the purification assembly so as to be traversed by this air and an inactive position where it does not ensure the filtration of the air, these active and inactive positions being controlled by the control means depending on at least one parameter representative of the quality of the air to be purified.

In a preferred configuration, the opening and closing means are valves. Such valves, preferably circular and pivoting in rotation about an axis located on a diameter of the valve, allow offering means being simple, effective and easy to implement for opening and closing the removable filtration cartridges.

Advantageously, an axial distance in a direction of circulation of the airflow between the upstream particulate pre-filtration module and the means for carrying out the forced air circulation is substantially equal to a distance between the inlet of the cartridges and said means for carrying out the forced air circulation.

According to the invention, the concept of «substantially equal» covers an equality within plus or minus 10%.

Advantageously, the axial distance in the direction of circulation of the airflow between the upstream particulate pre-filtration module and the means for carrying out the forced air circulation is substantially equal to a diameter of a cylindrical section taken perpendicular to the means for carrying out the forced air circulation.

According to an advantageous aspect, the invention also concerns one feature according to which the cartridges are assembled within a cartridge block, this cartridge block comprising a casing delimiting an intermediate chamber inside which the cartridges are housed such that said cartridges pass through said intermediate chamber in parallel relative to each other, and are held secured to each other.

This is particularly advantageous, in particular in the context of changing cartridges. It is then possible to make the cartridge block removable and handle all cartridges at the same time and easily. The filtration cartridges being consumable elements, this further facilitates the maintenance.

Moreover, another advantage is that it can equip an air purification assembly as described above in a new installation, but can also be installed on an existing air purification circuit, thus allowing offering an air purification assembly in which said cartridges are configured to be traversed in parallel by the polluted air circulating in the chamber in order to purify it, the cartridges being open and/or closed individually by the control means so as to adapt the air flow rate of the assembly depending on predetermined parameters of the quality of the air to be purified.

According to another aspect, the invention also concerns a method for controlling an air purification assembly according to the invention, during which the control means receive, from the measurement system, measurements of the parameters representative of the quality of the air to be purified, and the control means control the opening and closing mechanisms of the cartridges to open and close, distinctly or in combination, the cartridges so as to adapt the air flow rate depending on the parameters representative of the quality of the air to be purified.

Other features and advantages of the invention will become apparent on reading the following description, given only by way of example, with reference to the appended figures, which illustrate:

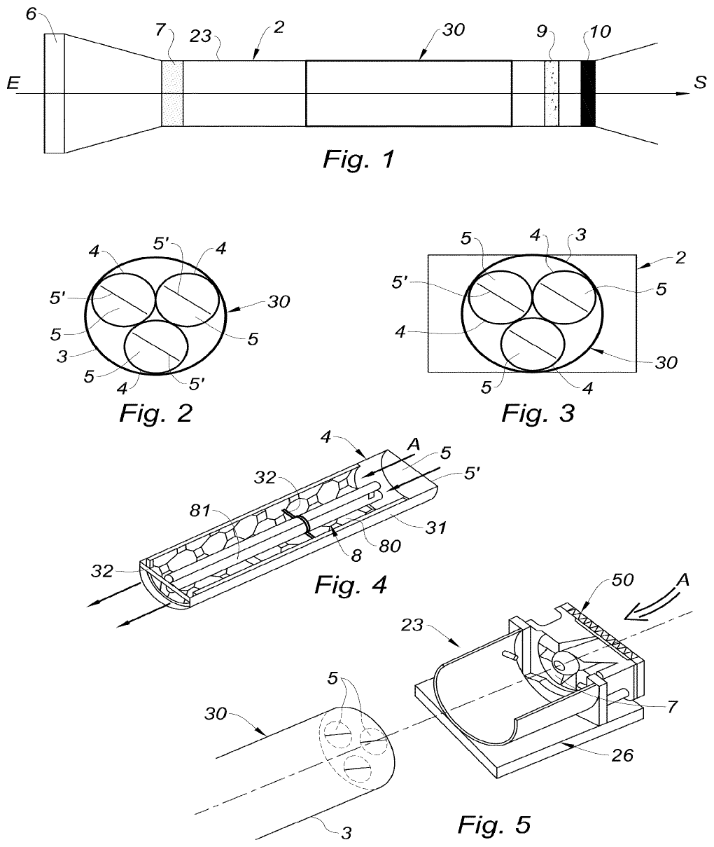

FIG. 1, a schematic view of an air purification assembly, according to one embodiment;

FIG. 2, a cross-sectional schematic view of a cartridge block of an air purification assembly, according to this embodiment;

FIG. 3, a cross-sectional schematic view of a chamber of an air purification assembly, according to this embodiment;

FIG. 4, a sectional and perspective view of a cartridge according to one embodiment;

FIG. 5, a partial view of an air purification assembly, according to one embodiment;

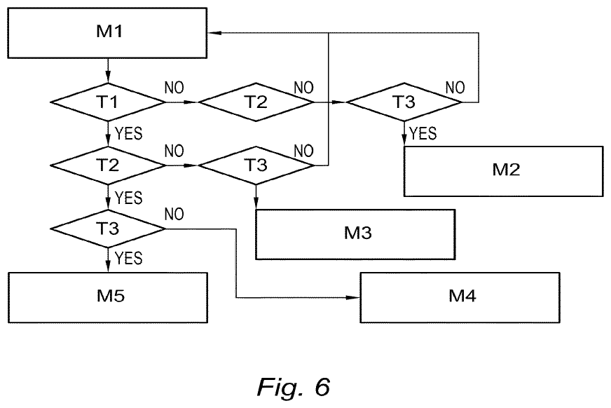

FIG. 6, a flowchart of a method for controlling an air purification assembly according to one embodiment.

In all these figures, identical or similar references designate identical or similar members or sets of members.

In the diagrams illustrated in FIGS. 1 to 3, the different constituent portions of an air purification assembly 1 are represented according to one embodiment of the present invention.

In general and with reference to FIG. 1, this purification assembly 1 is in the form of a chamber 2 which includes an air inlet «E» passing through or licking a wall of said chamber 2 through which the mixture of air and possible pollutants enters inside the purification assembly 1 forming the air purification and decontamination reactor.

The chamber 2 also comprises an air outlet «S» for the passage of the treated and purified air.

The chamber 2 also comprises a base 23 comprising at least means 7 for carrying out a forced air circulation inside the chamber 2 which are adapted to the volumes of air to be treated, which comprise for example at least one fan.

The fan 7 is preferably an axial fan comprising a frequency converter which combines flow rate and pressure drop efficiency with energy saving.

Such a fan can be replaced by a turbine, such as a centrifugal fan, and/or inert fan(s) used in medical applications.

The air purification assembly 1 further comprises a plurality of removable cartridges 4 housed inside the chamber 2, said cartridges 4 being adapted to be traversed in parallel by the polluted air circulating in the chamber to purify it, and said cartridges 4 forming air purification and decontamination cartridges.

The cartridges 4 are herein housed together in an intermediate chamber 3, this intermediate chamber 3 cooperating with the base 23 in order to be housed in said main chamber 2 and adapted to be traversed by the polluted air in order to purify it.

More specifically, the cartridges 4 are disposed alone on an intermediate air flow section in the chamber 2, in other words this intermediate chamber 3 is disposed in this intermediate section. Also, to pass through this intermediate section, the air can pass only through the cartridges 4, no short-circuiting (or “bypass”) flow channel being provided in or in parallel to this intermediate section to bypass or avoid the cartridges 4.

The set of cartridges 4 forming a cartridge block 30 and comprises a casing delimiting the intermediate chamber 3 inside which the cartridges 4 are housed such that said cartridges 4 pass through said intermediate chamber 3 in parallel to each other, and are held secured together. The inlets of the cartridges 4 are flush with each other and with an inlet face of the cartridge block 30. The same is true for the outlets of the cartridges 4 which are flush with each other and with an outlet face of the cartridge block 30.

In other words, the set of cartridges 4, housed in the intermediate chamber 3, form with it a cartridge unit 30, which is housed in a casing of the chamber 2, provided on the intermediate section, whose shape and dimensions are adapted to receive said cartridge bloc 30 so that it cooperates with the base 23 to be traversed by the polluted air in order to purify it.

This cartridge block 30 is preferably cylindrical and preferably placed concentrically relative to the main axis of circulation of the airflow to be purified, and more preferably concentrically relative to the air inlet E and/or the air outlet S of the purification assembly 1. The case where the cartridge block 30 is placed concentrically relative to the air inlet E and the air outlet S of the chamber 2 of the purification assembly 1 allows reducing at best the pressure losses.

The cartridges 4 are placed parallel to each other so as to be disposed in parallel in this cartridge block 30. In this manner, the cartridges 4 are adapted to be traversed in parallel by the polluted air circulating in the chamber 2 in order to purify it.

Thus, the cartridges 4 are placed parallel to each other in respective directions parallel to a main axis of circulation of the air to be purified inside the chamber 2 and, as shown in FIGS. 2 and 3, the cartridges 4 are distributed symmetrically about this main axis, thus offering a balance in terms of flow rate in the air circulation through the cartridges 4; this main axis being concentric relative to the air input E and the air output S of chamber 2.

Each of the cartridges 4 is provided, at the inlet thereof, with an opening and closing mechanism 5 configurable between an open configuration and a closed configuration for respectively allowing the air to circulate or for blocking the air circulation through the associated cartridge, the opening and closing mechanisms 5 being controlled by control means configured to open and close, distinctly or in combination, the cartridges 4 so as to adapt the air flow rate depending on predetermined parameters of the quality of the air to be purified. In this manner, the polluted air entering the chamber 2 passes through the intermediate section by circulating only through the cartridge(s) 4 whose opening and closing mechanism 5 is in the open configuration.

Thus, the air purification assembly 1 further comprises a measurement system for precisely measuring these parameters representative of the quality of the air to be purified, and the control means which are connected both to the measurement system and to the opening and closing mechanism 5 of each of the cartridges 4.

In this manner, the air purification assembly is versatile and the purification performance can be adapted depending on the air of the places where it is placed and the specific needs depending on the particularities thereof.

The control method thereof will be described in more detail with reference to FIG. 4.

This cartridge block 30, through which the forced circulation of the polluted air is organized to purify it, includes consumable polluted air filtration elements, that is to say, elements intended to be changed. According to the configurations, a user could change the cartridge block 30 or else the cartridges 4 independently of each other.

The filtration means comprise at least one photocatalytic cell 8 having a photocatalytic filter 80 and a light source 81 intended to irradiate said filter (see FIG. 4).

This purification assembly 1 is intended to equip an aeration and/or appropriate ventilation system which can be joined to the inlet and outlet thereof.

The chamber 2 has a housing of shape and dimensions which are adapted to receive the cylindrically shaped filtration cartridge block 30, as shown in FIG. 3.

It has, in the vicinity of the inlet, the base 23, of a substantially circular section.

This base 23 contains, as illustrated in FIG. 5, at least one motor-fan unit 7 forming a means for ensuring the forced circulation of the polluted air A into the chamber 2 through the purification assembly 1 and through the cartridge block 30.

This motor-fan unit 7 may comprise one or several fan(s) formed in the base 23 supplied by adapted means, which are described below, to assist the stirring of the polluted air A which is intended to be purified through the filter cartridge 30.

This motor-fan unit 7 has a variable speed depending on the needs of the air purification of the place where the assembly is placed, this in order to monitor the air flow rate passing through the purification assembly 1.

Furthermore, the base 23 comprises an electronic control system 26 (shown in FIG. 5) of the air purification assembly 1.

This electronic control system may comprise means for starting the air purification assembly 1.

It can also comprise means for automatically triggering said assembly 10 when the air pollution rate of the place, in which the assembly 1 is placed, reaches a certain pollution threshold, these triggering means being associated to adapted sensors present in the base 23.

In a non-limiting example of the present invention, the rate of micro particles suspended in the air can be continuously detected.

Moreover, as illustrated in FIG. 1, the means for filtering the polluted air entering the purification assembly 1 are divided into several filter modules successively disposed on the path of the air A to be purified.

It should be noted that each filter cartridge 4 and/or cartridge block 30 can be specific to the air A to be purified.

Thus an operator could replace a cartridge block 30 with another depending on the purification needs of the room in which the air purification assembly 10 is placed.

Advantageously, the purification assembly 1 according to the invention comprises filter modules associated to a particulate pre-filtration 6 upstream of the cartridges 4, in the front of the air circulation inside the assembly 1. This first filter module 6 comprises a pre-filter intended to trap the physical pollutants such as dust or particles.

This particulate pre-filtration module 6 is preferably placed within the chamber 2 upstream of the fan 7 (see FIG. 1) or downstream of the latter, but always upstream of the cartridge block 30 and/or of the photocatalytic cell 8.

More specifically, as illustrated in FIG. 1, this particulate pre-filtration module 6 is placed in the filtration cartridge 30 at the polluted air inlet, and placed concentrically with the elements of the photocatalytic cell 60, which will be described more precisely below.

This particulate pre-filtration module 6 offers the advantage of trapping particles as much as possible before the entry of the air A into the photocatalytic portion of the filter cartridges 4 and protecting the active sites of the latter.

This particulate pre-filtration module 6 can be with any adsorbent. An activated carbon filter or else a HEPA type high performance filter can be mentioned as an example.

However, the particulate pre-filtration module 6 can be formed by a combination of several different filters such that various substances can be removed from the air passing therethrough.

In an exemplary embodiment of the present invention, the pre-filter of the particulate pre-filtration module has a thickness in the range of 20 mm to 100 mm.

The cartridges 4 form, for their part, a second filter module. Each cartridge 4 comprises a sealed hollow cylindrical body 31 in which at least one photocatalytic filter 80 is placed and a light source 81 intended to irradiate said filter.

The cartridge block 30 is adapted to be removably fastened to the base 23 of the chamber 2 at one end to cooperate with the motor-fan unit 24.

Each of the cartridges extends longitudinally relative to the main axis of air circulation, that is to say parallel relative to this axis, to minimize the pressure losses.

Each cartridge 3 has an inlet located at a first end of the cylindrical body 31 in communication with the motor-fan unit 7 and an outlet located at a second end, opposite to the first end forming an inlet, that is to say still at the end opposite to the motor-fan unit 7.

The inputs of each of the cartridges, 3 in number in this embodiment, is provided with an opening and closing mechanism 5 for respectively allowing the air to circulate or for blocking the air circulation through the associated cartridge, this mechanism being in particular a valve 7.

Each of the valves has a shape adapted to cooperate with an inlet orifice of the associated cartridge 4. In the illustrated configuration, the valves 5 have the shape of a disc hinged in rotation about an axis 5′, in particular about a diametrical axis of said valve, that is to say passing through the disc of the valve along an axis passing through a diameter of its disc shape. Regardless of the shape of the valve 5, said valve is preferably hinged at the center thereof for a better efficiency and lower energy consumption.

In order to ensure the minimum pressure drop for a maximum flow rate, the axial distance in the direction of circulation of the airflow between the upstream particulate pre-filtration module 6 and the means 7 for carrying out the forced air circulation, namely the motor-fan unit 7, is substantially equal to the distance between the inlet of the cartridges 4 and said means for carrying out the forced air circulation 7, and preferably equal to the diameter of a cylindrical section of the chamber 2 in which they are housed taken perpendicular to the fan, corresponding in other words to the diameter of the fan 7.

At least one of the cartridges, preferably each of the cartridges, comprises, in the concavity thereof, one or several light source(s) 81.

In FIG. 4, in a non-limiting example, two parallel light sources 81 extend over almost the entire length of the cylinder 31 at the center of the latter. They thus irradiate over the entire length of the cylinder 31.

The catalytic filter 80, in turn, is in the form of a fibrous support coated with a photocatalytic agent.

The photocatalytic cell 8 is disposed, in the front of the air circulation A, downstream of the first filter module formed by the particulate pre-filtration module 6, concentrically relative to the latter in FIG. 4, such that products intermediates which may be formed by the pre-filter 6 can be eliminated.

Photocatalysis occurs at the surface of the photocatalytic agent, the latter being intended to adsorb and destroy the molecules of pollutant gases that pass through the purification assembly 1 thanks to oxidation reduction reactions under the effect of a radiation produced by the light source 81.

As illustrated in FIG. 4, the catalytic filter 80 is places concentrically with the light sources 81 and extend over the entire length of the cylinder 31.

Thus, the photocatalytic filter 80 has adapted shape and dimensions to be housed on the inner circumference of the cylinder 31 of the cartridge 3, along the latter.

The fact of surrounding the light sources 81 with the catalytic filter 80 offers the airflow, which licks and/or passes through the filter 80, a large treatment surface in a small and compact space and also offers a significant exchange surface between the airflow to be purified and the filter 80.

This exchange surface between the air to be purified and the photocatalytic filter 80 is accentuated by a turbulent airflow which can be created by the presence of the opening and closing mechanism 5 for respectively allowing the air to circulate or for blocking the air circulation through the associated cartridge.

The efficiency of photocatalysis is thus improved.

In order to maintain the light source(s) 81 globally concentric relative to the catalytic filter 80, the cylinder 31 of the cartridge 4 comprises radial fastening pins 32 relative to said cylindrical body, inside the latter (see FIG. 4). Preferably, a support pin 32 is positioned at the second end forming the outlet of the cartridge 4 and another support pin 32 is located approximately between the inlet and the outlet of the cartridge 4.

Advantageously, the photocatalytic agent is titanium dioxide TiO₂.

Of course, other catalytic agents could be used within the scope of the present invention, such as, in particular, other metal oxides, alkaline earth oxides, actinide oxides or rare earth oxides.

Preferably, the support of the photocatalytic agent is a fibrous medium which is transparent to the used radiation or any other support adapted to the photocatalysis.

In combination with such a photocatalytic agent, the light sources 81 are capable of emitting ultra-violet radiation.

They can thus comprise, without limitation, a tubular or flat ultraviolet ray lamp or a plurality of light-emitting diodes.

In a non-limiting example, the light sources 62 emit in the wavelengths of 254 nm.

In a non-limiting embodiment of the invention, the light source 62 is capable of emitting a UV power of 10 to 20 mW per cm² of irradiated surface.

Advantageously, the lamps or light-emitting diodes spend little energy. For example, their consumption is in the range of 4 W to 80 W.

In this manner, these light sources allow coupling catalytic decontamination efficiency and energy saving.

Under the effect of the photocatalytic cell 8, the airflow A passing through the purification assembly 1 becomes free from chemical and microbiological pollutants which are present in the ambient air.

Photocatalysis allows removing all components such as volatile organic compounds, odors, ozone, bacteria and molds, viruses, aldehydes, spores, fungi, allergenic mites by generating highly reactive hydroxyl radicals which attack the organic protection of the cells and totally degrade the chemical components present in the air.

There is also no formation of ozone thanks to the use of lamps with a glass that filters the generated wavelengths.

The cartridge block 30 further comprises, downstream of the photocatalytic cell 8, a third filter module 9 adapted for a chemical filtration of the air already treated by photocatalysis. In other words, the purification assembly 1 comprises a chemical filtration module 9 downstream of the cartridges 4, in the front of the air circulation inside the assembly 1.

According to the variant shown in FIG. 1, this chemical filtration module 9 is placed concentrically with the cartridge block 30, outside the cartridges 4.

However, a variant provides that the chemical filtration module 9 is placed concentrically with each photocatalytic filter 80 in each cartridge 30, between the photocatalytic filter 80 and the inner circumference of the body 31 of the associated cartridge 30.

Preferably, this chemical filtration module 9 is adapted to carry out oxidative chemical filtration which eliminates any emission of aldehydes.

A chemical filter may be mentioned as a non-limiting example, comprising an alumina support loaded with 8% potassium permanganate which quantitatively removes formaldehyde and sulfur-containing acids.

Other chemical filtration types of are also possible such as reductive, acid or base chemical filtration.

Catalysts which are particularly adapted for this use are those based on zeolite, capable of increasing the efficiency of the decontamination of organic materials and odorous molecules. Other catalysts can of course be used alone or in combination with, for example, complex ceramic structures, synthetic fibers, carbon fiber and coupling of titanium dioxide with other catalytic oxides such as zirconium dioxide allowing increasing the catalyst efficiency per unit volume.

The cartridge block 30 further comprises, downstream of the photocatalytic cell 8, and downstream of the chemical filtration module 9, a fourth filtration module 10 adapted for a particulate post filtration of the air which is already treated by photocatalysis and chemically treated. This particulate post filtration module 10 downstream of the cartridges 4, in the front of the air circulation inside the assembly and located either in the filtration cartridge 4 or outside the latter but inside the cartridge block 30, or outside the cartridge block 30. It is this last variant that is illustrated in FIG. 1.

In a variant which is not illustrated, each cartridge 4 comprises all consumable elements of the air purification assembly 1 that is to say that, it integrates a plurality of efficient technologies for the treatment of different classes of air pollutant of the indoor habitat where the air purification assembly 1 is placed.

Thus, for example, each cartridge can integrate the photocatalytic cell 8 but also a pre-filtration module 6 and/or a chemical filtration module 9 and/or a particulate post filtration module 10 in the concavity thereof.

This simplifies the replacement of cartridges and allows avoiding any contact between the filters and the hand of the operator which replaces the cartridge, thus eliminating any risk of contamination of the operator's hands.

Alternatively, it is the cartridge block itself that comprises all consumable elements of the air purification assembly 1, that is to say that it integrates a plurality of efficient technologies for the treatment of different classes of air pollutant of the indoor habitat where the air purification assembly 1 is placed.

In this case, for example, the cartridge block can integrate the pre-filtration module 6 and/or a chemical filtration module 9 and/or a particulate post filtration module 10 in the concavity of the intermediate chamber 3 thereof, these modules then being common to all cartridges.

This variant is particularly advantageous if it is provided to be able to replace the cartridge block in its entirety.

Moreover, the cartridge block 30 is connected to a power supply arriving in the chamber 2 by an adapted connection, in particular for powering the light sources 81.

Concerning the power supply to the motor-fan unit 7 and to the light source 81, one embodiment provides an external power supply of the mains terminal type.

An adapted connection set up in the chamber 2 of the assembly 1 allows connecting the light source(s) 62 when the cartridge block 30 is set up in chamber 2.

In another embodiment, the light source 81 and the motor-fan unit 7 can be powered by an energy accumulator 50 (see FIG. 5) placed in the base 23 of the chamber 2.

In one possible configuration, the energy accumulator (not illustrated) is kept charged and rechargeable by means for producing electrical energy from renewable energy integrated into the assembly.

In a non-limiting example, the air purification assembly 1 may comprise means for producing electrical energy from photovoltaic energy.

These means comprise means for capturing photovoltaic energy and transforming it into electrical energy stored in the energy accumulator, which is intended to provide the energy necessary for the light source 81.

Thanks to such means for producing electrical energy from renewable energy, an energy-efficient air purification assembly 1 is available.

An embodiment which is not illustrated can also provide a chamber 2 adapted to receive several cartridge blocks 30.

The operation of the air purification assembly 10 according to the present invention is as follows, related to FIG. 4, the air inlet being located at the motor-fan unit 7.

The ambient airflow A of a room is directed and channeled towards the motor-fan unit 7.

On its path, it passes through the particulate pre-filtration module 6. The solid pollutants present in the airflow A are then set by this particulate pre-filtration module 6.

The pre-filtered airflow A then passes through the photocatalytic cell 8.

The light source 81 emits an ultraviolet light beam toward the photocatalytic filter 80.

The photosensitive catalytic agent irradiated with ultraviolet radiation then reacts with the pollutants present in the pre-filtered airflow A, and, by catalysis reaction with the ultraviolet rays, permanently removes the pollutants that pass therethrough.

This is reinforced by the light source 81 with a germicidal effect that allows sterilizing the pre-filtered airflow A.

The airflow A thus sterilized is directed towards the chemical filtering module 9 to remove the remaining polluting elements and is directed towards the particulate pre-filtration module 10 then is directed towards the outlet of the chamber 2, for example in the room.

The replacement of a filtration cartridge 30 is performed as follows:
a fastening system also called «anti bypass» system, which allows strengthening holding the cartridge block 30 in the chamber 2 of the purification assembly 1, is disassembled;
the light sources 81 are disconnected from the power supply; then
the cartridge block 30 is rotated a quarter turn relative to the chamber 2 about the longitudinal axis thereof, and the assembly 30 is extracted from the chamber 2.

In order to place a new cartridge 30, the preceding steps are to be carried out in reverse.

Thus, the set 30 comprising the three photocatalytic cartridges is easily removable for example thanks to the fastening system by quarter turn screwing (preferably with a foolproof device). It is the assembly 30 which is replaced, thus avoiding any risk of direct contact of the operator with the photocatalytic cartridges 4.

The invention proposes a purification assembly 10 in which the replacement of a cartridge, and/or preferably of the cartridge block 30, is quick and simple while protecting the operator from the pollutants trapped in the filters of the used cartridges 4.

In a variant, an air purification assembly 1 is proposed comprising means for radio identification of the cartridges 4 (or of the cartridge block 30) placed in the chamber 2, of the RFID Radio Frequency Identification type for the recognition and the traceability of the cartridges.

Thus, the cartridges 4 can be provided with radio tags intended to cooperate with readers adapted for storing the data of the air purification assembly 10 concerning the installed filtration.

Thus, the advantage of being able to select a particular use of the air purification assembly 10 which is adapted depending on the installed cartridge is offered as a particular air flow rate and a particular fan speed 24 depending on the cartridge 4.

According to the invention, each of the cartridges is provided, at the inlet thereof, with an opening and closing mechanism 5 for respectively allowing the air to circulate or for blocking the circulation of air through the associated cartridge, the opening and closing mechanisms 5 being controlled by control means (not illustrated) configured to open and close, distinctly or in combination, the cartridges so as to adapt the air flow rate depending on predetermined parameters of the quality of the air to be purified.

In order to further improve the efficiency of the assembly 1 depending on the predetermined parameters of the quality of the air to be purified, at least one of the filters of the downstream chemical filtration 9 and downstream particulate post filtration 10 modules is removable between an active position where it is disposed on the path of the air circulating in the purification assembly 1 so as to be traversed by this air and an inactive position where it does not ensure the filtration of the air, these active and inactive positions being controlled by the control means.

The parameters of the quality of the air to be purified are measured by a plurality of sensors, allowing measuring, for example:
basic parameters, such as the temperature, the humidity or the relative humidity and the atmospheric pressure;
the presence of pollutants, among which for example: the volatile organic compounds (VOC), the volatile halogenated organic compounds (VHOC), aldehydes, ammonia, hydrogen sulfide, mercaptans, monoxides and carbon dioxide.

The means for controlling the purification assembly 1 comprise a control unit integrated into said purification assembly 1 receiving the data from each of the sensors and allowing controlling the flow rate of the purification assembly 1 at the pollution levels measured in the room as well as the types of treatment of polluted air necessary for the air purification.

The purification assembly 1 is servo-controlled both at the flow rate thereof to the pollution levels in the room and to the measurement of fine particles and gases in the air.

The signals are processed by the on-board control unit in the purification assembly 1. The different operating modes of the air decontamination device are preferably previously set before the installation and the operation thereof, for example in the factory, in order to be best adapted depending on the professional destination market. In this manner, several operating modes are pre-saved in a memory of the control means such that the purification assembly 1 operates in accordance with these operating modes depending on the measurements of the sensors.

Each operating mode is set to be adapted to particular configurations of the air to be treated.

According to an exemplary embodiment, a basic operating mode is the following:
at start-up, the valves forming the opening and closing mechanism 5 are open and the downstream chemical filtration 9 and downstream particulate post filtration 10 modules are in the active position. This operating mode guarantees a complete, rapid and efficient air decontamination.
as soon as the sensor(s) record(s) a drop in indoor air pollution, for example measured values less than 10% of the indoor air guide values (IAGV), two valves 5 are closed and the downstream chemical filtration 9 and downstream particulate post filtration 10 modules pass into an inactive position letting the decontaminated air pass more easily (reduction of the pressure drops and therefore of the energy consumption).

If the sensor(s) detects(s) a fine particle pollution, the particulate post filtration module 10 returns to the active position.

If the sensor(s) detects(s) a specific chemical pollution (acidity in the air, chlorinated compounds, ammonia, etc.), the downstream chemical filtration module 9 returns to the active position.

The means for controlling the purification assembly 1 controls the fan 7 so as to proportionally adapt the flow rate thereof depending on the operating modes. Any passage from one operating mode to another is preferably delayed.

With reference to FIG. 6, which illustrates a flowchart having examples of implementation depending on indoor air pollution values, five operating modes are detailed herein:
Mode M1 called «eco» mode: the purification assembly 1 operates so as to ensure a low flow rate and with a single open cartridge 4 traversed by the air to be decontaminated and a single activated photocatalytic cell 8, the chemical filtration 9 and particulate post filtration 10 modules being in the inactive position;
Mode M2 called «dust» mode: the purification assembly 1 operates so as to ensure a high flow rate, always with a single open cartridge 4 traversed by the air to be decontaminated and a single activated photocatalytic cell 8, but with the activated particulate post filtration module 10 to lower the level of dust concentration in the indoor air;
Mode M3 called «fast 1» mode: the purification assembly 1 operates so as to ensure an average flow rate with two open cartridges 4 traversed by the air to be decontaminated and two activated photocatalytic cells 8 in addition to the chemical filtration module 9 in the active position (to lower more efficiently the VOC concentration) and the particulate post filtration module 10 for dust.
Mode M4 called «fast 2» mode: the purification assembly 1 operates so as to ensure an average flow rate with two open cartridges 4 traversed by the air to be decontaminated and two activated photocatalytic cells 8 in addition to the chemical filtration module 9 in the active position, in order to more effectively lower the concentration of VOC and ammonia in the indoor air, the particulate post filtration module 10 being in the inactive position.
Mode M5 called «turbo» mode: the purification assembly 1 operates so as to ensure a high flow rate with all open cartridges 4, three in number, traversed by the air to be decontaminated and all activated photocatalytic cells 8, also three in number (each cartridge being associated to a photocatalytic cell), in addition to the two post-filtration modules, namely the chemical filtration 9 and particulate post filtration 10 modules in order to very effectively reduce all pollutants in the indoor air (the case of a very polluted room).

According to the embodiment which is illustrated in FIG. 6, these operating modes are active depending on measured parameters and compared to predetermined parameters of the quality of the air to be purified.

For example, three test steps can be implemented, among which:
a first step T1 of comparing the measured values of the VOC concentration relative to a threshold value: for example, is the measured value of VOC in polluted air greater than 5 ppm?
a second step T2 of comparing the measured values of the ammonia concentration: for example, is the measured value of NH₃ in the polluted air greater than 50 μg/m³?
a third step T3 for comparing the measured values of the dust concentration: for example, is the measured value of dust PM10 in the polluted air greater than 500 μg/m³?

Depending on the concentration tests T1, T2 and T3, an operating mode will be selected in accordance with the flowchart of FIG. 6.

As we have just seen, the invention concerns a method for controlling an air purification assembly 1 as described above, during which the control means receive, from the measurement system, measurements of the parameters representative of the quality of the air to be purified, and the control means control the opening and closing mechanisms 5 of the cartridges 4 to open and close, distinctly or in combination, the cartridges 4 so as to adapt the air flow rate depending on the parameters representative of the quality of the air to be purified.

In general, the control method comprises the implementation of a plurality of steps for checking the air quality (such as steps T1, T2 and T3) implemented successively, so that the means for controlling the air purification assembly 1 ensure the operation thereof in a predetermined operating mode.

These predetermined operating modes vary in particular by adapting the air flow rate depending on predetermined parameters of the quality of the air to be purified, preferably by varying:
the power of the means 7 for carrying out the forced air circulation in the chamber, i.e. the speed of rotation of the fan;
the active or inactive positions of the chemical filtration 9 and particulate post filtration 10 modules, or even of the particulate pre-filtration module 6 when it is removable and more generally of any other filtration module which would equip the assembly 1 and which would be configured to be removable between the active and inactive positions;
the activation of the photocatalytic cells 8, in particular by the activation of the light sources 81 thereof;
the opening or closing of the valves 5 forming opening and closing mechanisms 5 which are controlled independently of each other by the control means.

This control for closing and opening each of the cartridges by the control means, this individually, allows a particularly improved management of the flow rate while guaranteeing a significant energy saving compared to the solutions of the prior art.

Those skilled in the art will appreciate, relative to the purification assemblies of the prior art, a versatile assembly allowing, by replacement of filtration cartridges and/or specific cartridge blocks, to be adapted to the place in which it is placed in a simple and quick manner while ensuring an efficiency of purification of the indoor air which is perfectly adapted and specific to the pollution type and rate.

He will also appreciate a n assembly which is easy to maintain and does not require much space and energy by taking specific account of the room needs whose air must be decontaminated, simple to design and install, and which can be used by any person in any living space where purification of the indoor air is desired.

Furthermore, the cartridge block 30 can equip an air purification assembly as described above in a new installation, but can also be installed on an existing air purification circuit, thus allowing offering an air purification assembly in which said cartridges are configured to be traversed in parallel by the polluted air circulating in the chamber in order to purify it, the cartridges being open and/or closed individually by the control means so as to adapt the air flow rate of the assembly depending on predetermined parameters of the quality of the air to be purified.

In the illustrated example, the cartridge unit 30 is sized to accommodate flow rates in the range of 1000 m³/h, and can be integrated inside the existing ducts of the Air Handling Units (AHUs) of the buildings.

The invention is described in the above by way of example. It is understood that those skilled in the art are able to carry out different embodiments of the invention without departing from the scope of the invention.

For example, the air purification assembly 1 may include, at the outlet thereof, deflectors allowing the outlet air to be directed in a desired direction, by means for example of fins, elbows, or any other deflectors adapted for this use

Moreover, the number of cartridges equipping the purification assembly and/or the cartridge block may vary. For example, it could integrate seven cartridges disposed in parallel on the path of the air circulating in the assembly. This number may vary depending on the dimensions of the equipment depending on its use and the dimensions of the cartridges, to further limit the pressure drops.

1. An air purification assembly comprising:
a chamber comprising an air inlet for the passage of a polluted air, an air outlet for the passage of a purified air and a base provided with means for carrying out a forced air circulation in the chamber,
a plurality of removable cartridges housed in the chamber, the cartridges being adapted to be traversed in parallel by the polluted air circulating in the chamber in order to purify it,
each of the cartridges being provided, at the inlet thereof, with an opening and closing mechanism configurable between an open configuration and a closed configuration for respectively allowing the air to circulate or for blocking the circulation of air through the associated cartridge,
the air purification assembly further comprising:
a measurement system for measuring parameters representative of the quality of the air to be purified;
control means connected to the measurement system and to the opening and closing mechanism of each of the cartridges, the control means being configured to control the opening and closing mechanisms in order to open and close individually the cartridges so as to adapt the air flow rate depending on parameters representative of the quality of the air to be purified.

2. The air purification assembly according to claim 1, wherein the cartridges are disposed alone on an intermediate air flow section in the chamber, such that the polluted air entering the chamber passes through the intermediate section by circulating only through the cartridge(s) whose opening and closing mechanism is in the open configuration.

3. The air purification assembly according to claim 1, wherein the cartridges are placed parallel to each other in respective directions parallel to a main axis of circulation of the air to be purified, and the cartridges are symmetrically distributed around this main axis.

4. The air purification assembly according to claim 3, wherein the main axis is concentric relative to the air inlet and the air outlet of the chamber.

5. The air purification assembly according to claim 1, wherein each of the cartridges comprises at least one consumable photocatalytic cell having a photocatalytic filter and a light source intended to irradiate said photocatalytic filter.

6. The air purification assembly according to claim 1, comprising at least one downstream filtration module disposed downstream of the cartridges, in the front of the air circulation inside the assembly.

7. The air purification assembly according to claim 6, wherein the downstream filtration module is removable between an active position where it is disposed on the path of the air circulating inside the purification assembly so as to be traversed by this air and an inactive position where it does not ensure the filtration of the air, these active and inactive positions being controlled by the control means depending on at least one parameter representative of the quality of the air to be purified.

8. The air purification assembly according to claim 6, wherein at least one downstream filtration module is a chemical filtration module.

9. The air purification assembly according to claim 7, wherein the measurement system comprises means for measuring a chemical pollution rate, and the chemical filtration module is removable between an active position and an inactive position, these active and inactive positions being controlled by the control means depending on this chemical pollution rate.

10. The air purification assembly according to claim 9, wherein the means for measuring a chemical pollution rate is designed to measure a presence of at least one pollutant selected from the volatile organic compounds, the volatile halogenated organic compounds, aldehydes, ammonia, hydrogen sulfide, mercaptans, monoxides and carbon dioxide.

11. The air purification assembly according to claim 6, wherein a downstream filtration module is a particulate post filtration module.

12. The air purification assembly according to claim 7, wherein the measurement system comprises means for measuring a fine particle pollution rate, and the particulate post filtration module is removable between an active position and an inactive position, these active and inactive positions being controlled by the control means depending on this fine particle pollution rate.

13. The air purification assembly according to claim 1, comprising a particulate pre-filtration module which is upstream of the cartridges, in the front of the air circulation inside the assembly.

14. The air purification assembly according to claim 13, wherein an axial distance in a direction of circulation of the airflow between the upstream particulate pre-filtration module and the means for carrying out the forced air circulation is substantially equal to a distance between the inlet of the cartridges and the means for carrying out the forced air circulation.

15. The air purification assembly according to claim 14, wherein the axial distance in the direction of circulation of the airflow between the upstream particulate pre-filtration module and the means for carrying out the forced air circulation is substantially equal to a diameter of a cylindrical section taken perpendicular to the means for carrying out the forced air circulation.

16. The air purification assembly according to claim 1, wherein the opening and closing means are valves.

17. The air purification assembly according to claim 1, wherein the cartridges are assembled within a cartridge block, the cartridge block comprising a casing delimiting an intermediate chamber inside which the cartridges are housed such that the cartridges pass through said intermediate chamber in parallel relative to each other, and are held secured to each other.

18. A method for controlling an air purification assembly according to claim 1, during which the control means receive, from the measurement system, measurements of the parameters representative of the quality of the air to be purified, and the control means control the opening and closing mechanisms of the cartridges to open and close, distinctly or in combination, the cartridges so as to adapt the air flow rate depending on the parameters representative of the quality of the air to be purified.
